(19) United States
(12) Patent Application Publication
(10) Pub. No.: US 2021/0166123 A1
(43) Pub. Date: Jun. 3, 2021

(54) METHOD FOR TRAINING A ROBUST DEEP NEURAL NETWORK MODEL

(71) Applicant: NavInfo Europe B.V., Eindhoven (NL)

(72) Inventors: Bahram Zonooz, Eindhoven (NL); Fahad Sarfraz, Eindhoven (NL); Elahe Arani, Eindhoven (NL)

(21) Appl. No.: 17/107,455

(22) Filed: Nov. 30, 2020

(30) Foreign Application Priority Data
Nov. 29, 2019 (NL) 2024341
Mar. 26, 2020 (NL) 2025214

(51) Int. Cl. G06N 3/08; G06N 3/04; G06K 9/62

(52) U.S. Cl. CPC G06N 3/08; G06K 9/6242; G06N 3/04

(57) ABSTRACT

A method for training a robust deep neural network model in collaboration with a standard model in a minimax game in a closed learning loop. The method encourages the robust and standard models to align their feature spaces by utilizing the task-specific decision boundaries and explore the input space more broadly. The supervision from the standard model acts as a noise-free reference for regularizing the robust model. This effectively adds a prior on the learned representations which encourages the model to learn semantically relevant features which are less susceptible to off-manifold perturbations introduced by adversarial attacks. The adversarial examples are generated by identifying regions in the input space where the discrepancy between the robust and standard model is maximum within the perturbation bound. In the subsequent step, the discrepancy between the robust and standard models is minimized in addition to optimizing them on their respective tasks.

### CROSS-REFERENCE TO RELATED APPLICATIONS

This application claims priority to Netherlands Patent Application No. 2024341, titled “A Method for Training a Robust Deep Neural Network Model”, filed on Nov. 29, 2019, and Netherlands Patent Application No. 2025214, titled “A Method for Training a Robust Deep Neural Network Model”, filed on Mar. 26, 2020, and the specification and claims thereof are incorporated herein by reference.

### BACKGROUND OF THE INVENTION

### Field of the Invention

Embodiments of the present invention relate to a method for training a robust deep neural network model.

### Background Art

Deep neural networks (DNNs) have emerged as a predominant framework for learning multiple levels of representation, with higher levels representing more abstracts aspects of the data [lit. 2]. The better representation has led to state-of-the-art performance in many challenging tasks in computer vision [lit. 12, 20], natural language processing [lit. 4, 22] and many other domains [lit. 8, 17]. However, despite their pervasiveness, recent studies have exposed the lack of robustness of DNNs to various forms of perturbations [lit. 6, 9, 19]. In particular, adversarial examples which are small imperceptible perturbations of the input data carefully crafted by adversaries to cause erroneous predictions pose a real security threat to DNNs deployed in critical applications [lit. 13].

The intriguing phenomenon of adversarial examples has garnered a lot of attention in the research community [lit. 23] and progress has been made in both creating stronger attacks to test the model's robustness [lit. 3, 5, 16, 21] as well as defenses to these attacks [lit. 14, 15, 24]. However, Athalye et al. [Lit. 1] show that most of the proposed defense methods rely on obfuscated gradients which is a special case of gradient masking and lowers the quality of the gradient signal causing gradient based attack to fail and give a false sense of robustness. They observe adversarial training [Lit. 15] as the only effective defense method. The original formulation of adversarial training, however, does not incorporate the clean examples into its feature space and decision boundary. On the other hand, Jacobsen et al. [Lit. 10] provide an alternative view point and argue that the adversarial vulnerability is a consequence of narrow learning, resulting in classifiers that rely only on a few highly predictive features in their decisions. A full understanding of the major factors that contribute to adversarial vulnerability in DNNs has not yet been developed and consequently the optimal method for training robust models remains an open question.

The current state-of-the-art method, TRADES [Lit. 24] adds a regularization term on top of a natural cross-entropy loss which forces the model to match its embeddings for a clean example and a corresponding adversarial example. However, there might be an inherent tension between the objective of adversarial robustness and that of natural generalization [Lit. 25].

Therefore, combining these optimization tasks together into a single model and forcing the model to completely match the feature distributions of the adversarial and clean examples may lead to sub-optimal solutions.

### BRIEF SUMMARY OF THE INVENTION

It is an object of embodiments of the present invention to address the above highlighted shortcomings of current adversarial training approaches.

Within the scope of the invention, the optimization for adversarial robustness and generalization are considered as two distinct yet complementary tasks, and encouraging a more exhaustive exploration of the input and parameter space can lead to better solutions.

To this end, embodiments of the present invention are directed to a method for training a deep neural network model which trains a robust model in conjunction with a natural model in a collaborative manner.

The method utilizes task specific decision boundaries to align the feature space of the robust and natural model in order to learn a more extensive set of features which are less susceptible to adversarial perturbations.

Embodiments of the present invention closely intertwine the training of a robust and natural model by involving them in a minimax game inside a closed learning loop. The adversarial examples are generated by determining regions in the input space where the discrepancy between the two models is maximum.

In a subsequent step, each model minimizes a task specific loss which optimizes the model on its specific task, in addition to a mimicry loss that aligns the two models.

The formulation comprises bi-directional knowledge distillation between a clean and an adversarial domain, enabling the models to collectively explore the input and parameter space more extensively. Furthermore, the supervision from the natural model acts as a regularizer which effectively adds a prior on the learned representations and leads to semantically meaningful features that are less susceptible to off-manifold perturbations introduced by adversarial attacks.

In summary, embodiments of the present invention entail training an adversarially robust model in conjunction with a natural model in a collaborative manner (FIG. 1). The goal is to utilize the task specific decision boundaries to align the feature space of the robust and natural model in order to learn a more extensive set of features which are less susceptible to adversarial perturbations. Adversarially Concurrent Training ACT closely intertwines the training of a robust and a natural model by involving them in a minimax game inside a closed learning loop. The adversarial examples are generated by identifying regions in the input space where the discrepancy between the robust and natural model is maximum. In a subsequent step, the discrepancy between the two models is minimized in addition to optimizing them on their respective tasks.

Embodiments of the present invention have a number of advantages. The adversarial perturbations generated by identifying regions in the input space where the two models disagree can be effectively used to align the two models and leads to more smoother decision boundaries (see FIG. 2). Involving both models in the adversarial examples generation step adds more variability in the directions of the adversarial perturbations and pushes the two models to collectively explore the input space more extensively. In the traditional method of creating adversarial examples, the adversarial perturbation direction is based only on higher loss values. In the method of the invention, in addition to increasing the loss, it also maximizes the discrepancy between the two models. Because the two models are being updated concurrently and are diverged, this essentially adds more variability in the direction of the adversarial perturbations.

Also, updating the models based on the disagreement regions in the input space coupled with optimization on distinct tasks ensures that the two models do not converge to a consensus. Furthermore, the supervision from the natural model acts as a noise-free reference for regularizing the robust model. This effectively adds a prior on the learned representations which encourages the model to learn semantically relevant features in the input space. Coupling this with the affinity of the robust model pushes the model towards features with stable behaviour within the perturbation bound.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 shows a scheme of an adversarial concurrent training of a robust model in conjunction with a natural model; and

FIG. 2 provides an illustration of an embodiment of the present invention on a binary classification problem.

### DETAILED DESCRIPTION OF THE INVENTION

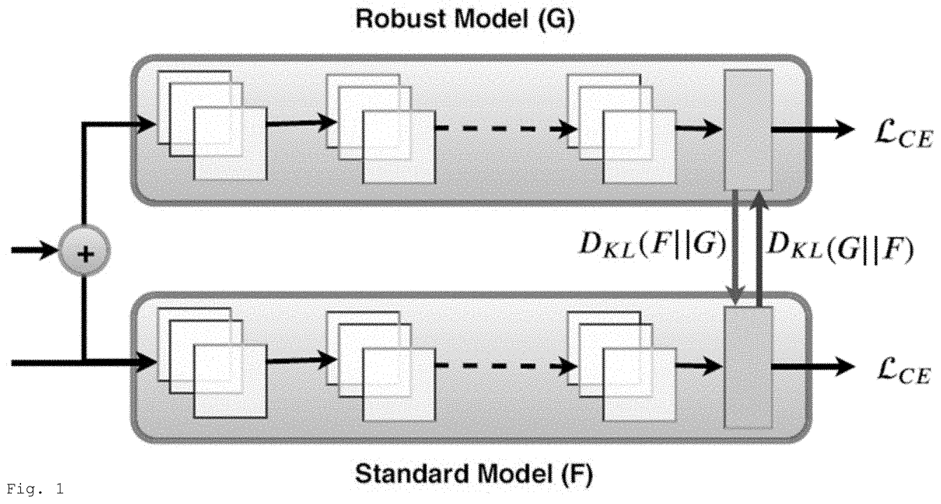

FIG. 1 highlights the difference of the robust model and the natural model. The standard model is trained on the original images, x, whereas the robust model is trained on adversarial images (adversarial perturbation, δ, is added to the original images). The models are then trained on the task specific loss as well as the mimicry loss.

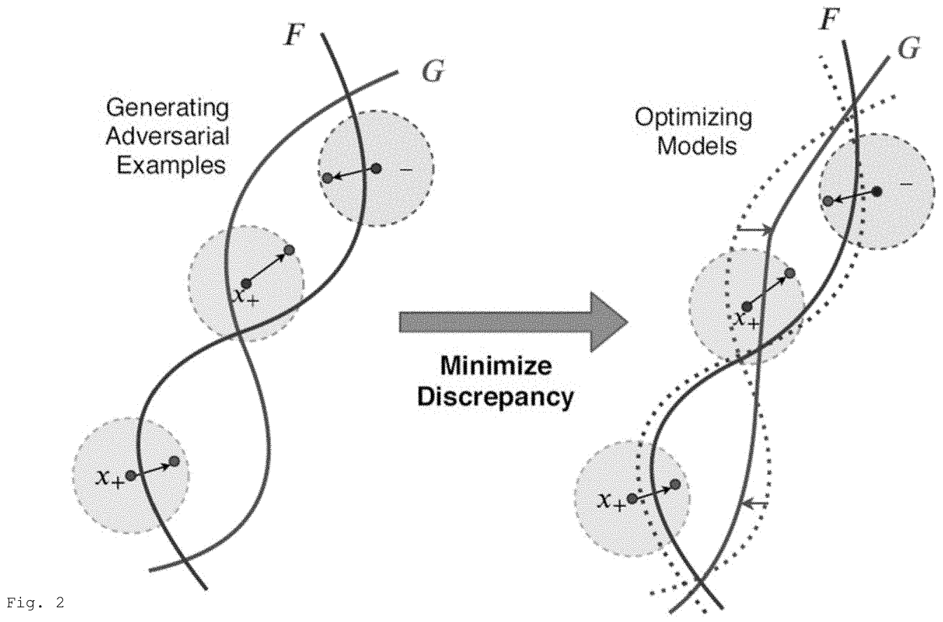

Referring to FIG. 2 illustrating an embodiment of the present invention, adversarial examples are preferably first generated by identifying discrepancy regions between a robust model and a natural model. The arrow in the circles shows the direction of the adversarial perturbation and the circles show the perturbation bound. In a subsequent step, the discrepancy between the models is minimized. This effectively aligns the two decision boundaries and pushes them further from the examples. Therefore, as training progresses, the decision boundaries get smoother. On the right diagram the dotted lines show the decision boundary before updating the models and the right one shows the updated decision boundary.

The following discussion applies to the training method of the invention with reference to FIG. 1.

Each model, i.e. the robust model and the natural model, is trained with two losses: a task specific loss and a mimicry loss which is used to align each model with the other one. The natural cross-entropy between the output of the model and the ground truth class labels is used as a task specific loss, indicated by L_{CE}. To align the output distributions of the two models, the method uses made of Kullback-Leibler Divergence (D_{KL}) as the mimicry loss. The robust model, G, minimizes the cross-entropy on adversarial examples and the class labels, in addition to minimizing a discrepancy between its predictions on adversarial examples and the soft-labels from the natural model on clean examples.

The adversarial examples are generated by identifying regions in the input space where the discrepancy between the robust and natural model is maximum (Maximizing Equation 1).

The overall loss function for the robust model parametrized by θ is as follows:

[symbol]

_{G}(θ,ϕ,δ)=(1−α_{G}) [symbol] _{CE}(G(x+δ;θ),y)+α_{G}D_{DL}(G(x+δ;θ)∥F(x;ϕ)) Equation 1:

where x is the input image to the model and δ is the adversarial perturbation.

The natural model, F, uses the same loss function as the robust model, except it optimizes the generalization error by minimizing the task specific loss on clean examples. The overall loss function of the natural model parametrized by φ is as follows:

[symbol]

_{F}(θ,ϕ,δ)=(1−α_{F}) [symbol] _{CE}(F(x;ϕ),y)+α_{F}D_{KL}(F(x;ϕ)∥G(x+δ;θ) Equation 2:

The tuning parameters α_{G}, α_{F}∈[0,1] play key roles in balancing the importance of task specific and alignment errors.

The algorithm for training the models is summarized below:

Algorithm 1 Adversarial Concurrent Training Algorithm
Input: Dataset D, Balancing factors α_{G} and α_{F}, Learning
rate η, Batch size m
Initialize: G and F parameterized by θ and ϕ
while Not Converged do
| 1: Sample mini-batch: (x₁, y₁), . . . , (xₘ, yₘ) ~ D
| 2: Compute advesarial examples:
| δ* = arg max_{δ∈S} [symbol] _{G} (θ, ϕ, δ)
| 3: Compute [symbol] _{G} (θ, ϕ, δ) (Equation 1)
| Compute [symbol] _{F} (θ, ϕ, δ) (Equation 2)
| 4: Compute stochastic gradients and update the paramet-
| ers:
| $θ ← θ - η \frac{\partial {ℒ}_{G}}{\partial θ}$
└ $φ ← φ - η \frac{\partial {ℒ}_{F}}{\partial φ}$
return θ* and ϕ*

### Empirical Validation

The effectiveness of the method according to the invention is empirically compared to prior art training methods of Madry [lit. 15] and TRADES [lit. 24]. The table below shows the effectiveness of adversarial concurrent training ACT across different datasets and network architectures.

In this analysis CIFAR-10 [lit. 11] and CIFAR-100 [lit. 11] datasets are used and ResNet [lit. 7] and WideResNet [lit. 26] network architectures. In all experiments, the images are normalized between 0 and 1 and for training random cropping is applied with reflective padding of 4 pixels and random horizontal flip data augmentations.

For training ACT, Stochastic Gradient Descent with momentum is used; 200 epochs; batch size 128; and an initial learning rate of 0.1, decayed by a factor of 0.2 at epochs 60, 120 and 150.

For Madry and TRADES, the training scheme used in lit. 24 is applied. To generate the adversarial examples for training, we set the perturbation ε=0.031, perturbation step size η=0.007, number of iterations K=10. For a fair comparison, we use λ=5 for TRADES which they report achieves the highest robustness for ResNet18.

Our re-implementation achieves both better robustness and generalization than reported in lit. 24. The adversarial robustness of the model is evaluated with Projected Gradient Descent (PGD) attack [lit. 15], the perturbation ε=0.031, perturbation step size η=0.003 and the number of iterations K=20.

TABLE
Comparison of ACT with prior defense models under white-box attacks. ACT consistently achiever higher
robustness and generalization across the different architectures and datasets compared to TRADES.

| | | | | A_{rob} | | | Minimum |
|---|---|---|---|---|---|---|---|
| | Dataset | Defense | Aₙₐₜ | PGD-20 | PGD-100 | PGD-1000 | Perturbation |
| ResNet-18 | CIFAR-10 | Madry | 85.11 ± 0.17 | 50.53 ± 0.02 | 47.67 ± 0.23 | 47.51 ± 0.20 | 0.03796 |
| | | TRADES | 83.49 ± 0.33 | 53.79 ± 0.36 | 52.15 ± 0.32 | 52.12 ± 0.31 | 0.04204 |
| | | ACT | 84.33 ± 0.23 | 55.83 ± 0.22 | 53.73 ± 0.23 | 53.62 ± 0.23 | 0.04486 |
| | CIFAR-100 | Madry | 58.36 ± 0.09 | 24.48 ± 0.20 | 23.10 ± 0.25 | 23.02 ± 0.28 | 0.01951 |
| | | TRADES | 56.91 ± 0.40 | 28.88 ± 0.20 | 27.98 ± 0.21 | 27.96 ± 0.24 | 0.02337 |
| | | ACT | 61.56 ± 0.14 | 31.14 ± 0.20 | 29.74 ± 0.18 | 29.71 ± 0.17 | 0.02459 |
| WRN-28-10 | CIFAR-10 | Madry | 87.26 ± 0.17 | 49.76 ± 0.07 | 46.91 ± 0.13 | 46.77 ± 0.07 | 0.04508 |
| | | TRADES | 86.36 ± 0.22 | 53.52 ± 0.21 | 50.73 ± 0.22 | 50.63 ± 0.21 | 0.04701 |
| | | ACT | 87.58 ± 0.14 | 54.94 ± 0.18 | 50.66 ± 0.13 | 50.44 ± 0.16 | 0.05567 |
| | CIFAR-100 | Madry | 60.77 ± 0.14 | 24.92 ± 0.32 | 23.56 ± 0.31 | 23.46 ± 0.30 | 0.02094 |
| | | TRADES | 58.10 ± 0.14 | 28.49 ± 0.10 | 27.50 ± 0.28 | 27.44 ± 0.29 | 0.02411 |
| | | ACT | 60.72 ± 0.16 | 28.74 ± 0.17 | 27.32 ± 0.01 | 27.26 ± 0.02 | 0.02593 |

Specifically, for ResNet18 on CIFAR-100 and WRN-28-10 on CIFAR-10, ACT significantly improves both the generalization and the robustness compared to Madry and TRADES. ACT consistently achieves better robustness and generalization compared to TRADES. In instances where Madry has better generalization, the difference in the robustness is considerably larger.

To test the adversarial robustness of the models more extensively, the average minimum perturbation required to successfully fool the defense methods is also evaluated. The FGSMₖ in foolbox [It. 18] is applied, which returns the smallest perturbation under the I_{inf} distance. The table shows that ACT consistently requires higher perturbation in images on average across the different datasets and network architectures.

Optionally, embodiments of the present invention can include a general or specific purpose computer or distributed system programmed with computer software implementing steps described above, which computer software may be in any appropriate computer language, including but not limited to C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Although the invention has been discussed in the foregoing with reference to an exemplary embodiment of the training method of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Note that this application refers to a number of publications. Discussion of such publications herein is given for more complete background and is not to be construed as an admission that such publications are prior art for patentability determination purposes.

The referenced cited herein are as follows:
[1] Athalye, A., Carlini, N., and Wagner, D. (2018). Obfuscated gradients give a false sense of security: Circumventing defenses to adversarial examples. arXiv preprint arXiv:1802.00420. 1, 2, 7
[2] Bengio, Y. (2013). Deep learning of representations: Looking forward. In International Conference on Statistical Language and Speech Processing, pages 1-37. Springer. 1
[3] Carlini, N. and Wagner, D. (2017). Towards evaluating the robustness of neural networks. In 2017 IEEE Symposium on Security and Privacy (SP), pages 39-57. IEEE. 1, 2
[4] Collobert, R. and Weston, J. (2008). A unified architecture for natural language processing: Deep neural networks with multitask learning. In Proceedings of the 25th international conference on Machine learning, pages 160-167. ACM. 1
[5] Goodfellow, I. J., Shlens, J., and Szegedy, C. (2014). Explaining and harnessing adversarial examples. arXiv preprint arXiv:1412.6572. 1, 2
[6] Gu, K., Yang, B., Ngiam, J., Le, Q., and Shlens, J. (2019). Using videos to evaluate image model robustness. arXiv preprint arXiv:1904.10076. 1
[7] He, K., Zhang, X., Ren, S., and Sun, J. (2015). Deep residual learning for image recognition. computer vision and pattern recognition (cvpr). In 2016 IEEE Conference on, volume 5, page 6. 2, 4
[8] Heaton, J., Poison, N., and Witte, J. H. (2017). Deep learning for finance: deep portfolios. Applied Stochastic Models in Business and Industry, 33(1):3-12. 1
[9] Hendrycks, D. and Dietterich, T. (2019). Benchmarking neural network robustness to common corruptions and perturbations. arXiv preprint arXiv:1903.12261. 1
[10] Jacobsen, J.-H., Behrmann, J., Zemel, R., and Bethge, M. (2018). Excessive invariance causes adversarial vulnerability. arXiv preprint arXiv:1811.00401. 1, 3, 7
[11] [Krizhevsky et al.] Krizhevsky, A., Nair, V., and Hinton, G. Cifar-10 (canadian institute for advanced research). 2, 4
[12] Krizhevsky, A., Sutskever, I., and Hinton, G. E. (2012). Imagenet classification with deep convolutional neural networks. In Advances in neural information processing systems, pages 1097-1105. 1
[13] Kurakin, A., Goodfellow, I., and Bengio, S. (2016). Adversarial examples in the physical world. arXiv preprint arXiv:1607.02533. 1
[14] Lamb, A., Verma, V., Kannala, J., and Bengio, Y. (2019). Interpolated adversarial training: Achieving robust neural networks without sacrificing too much accuracy. In Proceedings of the 12th ACM Workshop on Artificial Intelligence and Security, pages 95-103. ACM. 1, 2, 8
[15] Madry, A., Makelov, A., Schmidt, L., Tsipras, D., and Vladu, A. (2017). Towards deep learning models resistant to adversarial attacks. arXiv preprint arXiv:1706.06083. 1, 2, 5
[16] Moosavi-Dezfooli, S.-M., Fawzi, A., and Frossard, P. (2015). Deepfool: a simple and accurate method to fool deep neural networks. corr abs/1511.04599 (2015). arXiv preprint arXiv:1511.04599. 1,
[17] Pierson, H. A. and Gashler, M. S. (2017). Deep learning in robotics: a review of recent research. Advanced Robotics, 31(16):821-835. 1
[18] Rauber, J., Brendel, W., and Bethge, M. (2017). Foolbox: A python toolbox to benchmark the robustness of machine learning models. arXiv preprint arXiv:1707.04131. 5
[19] Szegedy, C., Zaremba, W., Sutskever, I., Bruna, J., Erhan, D., Goodfellow, I., and Fergus, R. (2013). Intriguing properties of neural networks. arXiv preprint arXiv:1312.6199. 1, 2
[20] Voulodimos, A., Doulamis, N., Doulamis, A., and Protopapadakis, E. (2018). Deep learning for computer vision: A brief review. Computational intelligence and neuroscience, 2018. 1
[21] Xiao, C., Zhu, J.-Y., Li, B., He, W., Liu, M., and Song, D. (2018). Spatially transformed adversarial examples. arXiv preprint arXiv:1801.02612. 1
[22] Young, T., Hazarika, D., Poria, S., and Cambria, E. (2018). Recent trends in deep learning based natural language processing. ieee Computational intelligenCe magazine, 13(3):55-75. 1
[23] Yuan, X., He, P., Zhu, Q., and Li, X. (2019). Adversarial examples: Attacks and defenses for deep learning. IEEE transactions on neural networks and learning systems. 1
[24] Zhang, H., Yu, Y., Jiao, J., Xing, E. P., Ghaoui, L. E., and Jordan, M. I. (2019). Theoretically principled trade-off between robustness and accuracy. arXiv preprint arXiv:1901.08573. 1, 2, 3, 4, 5
[25] Tsipras, D., Santurkar, S., Engstrom, L., Turner, A., and Madry, A. Robustness may be at odds with accuracy. arXiv preprint arXiv:1805.12152, 2018.
[26] Zagoruyko, S. and Komodakis, N. (2016). Wide residual networks. arXiv preprint arXiv:1605.07146. 2, 4

What is claimed is:

1. A method for training a robust deep neural network model, comprising collaboratively training the robust model in conjunction with a natural model.

2. The method of claim 1, wherein feature spaces of the robust model and the natural model are aligned utilizing task specific decision boundaries in order to learn a more extensive set of features which are less susceptible to adversarial perturbations.

3. The method of claim 1, wherein the training of the robust and natural models is done concurrently, involving them in a minimax game inside a closed learning loop.

4. The method of claim 3, wherein adversarial examples are generated by determining regions in an input space where there exists maximum discrepancy between the robust model and the natural model.

5. The method of claim 4, wherein the step of generating adversarial examples by identifying regions in the input space where the robust model and the natural model disagree is used to align the robust model and the natural model so as to promote smoother decision boundaries.

6. The method of claim 3, wherein the robust model and the natural model each minimizes a task specific loss which optimises the robust model and the natural model on their specific tasks, in addition to minimizing a mimicry loss so as to align the robust model and the natural model.

7. The method of claim 1, wherein optimization for adversarial robustness and generalization are treated as distinct yet complementary tasks so as to encourage exhaustive exploration of the models input and parameter space.

8. The method of claim 1, wherein both the robust model and the natural model are involved in the adversarial examples generation step so as to promote variability in the directions of the adversarial perturbations and pushing the robust model and the natural model to collectively explore the input space more extensively.

9. The method of claim 1, wherein the robust model and the natural model are updated based on disagreement regions in the input space coupled with optimization on distinct tasks, so as to ensure that the robust model and the natural model do not converge to a consensus.

10. The method of claim 1, wherein supervision from the natural model acts as a noise-free reference for regularizing the robust model.
